(19) United States
(12) Patent Application Publication
(10) Pub. No.: US 2018/0223221 A1
(43) Pub. Date: Aug. 9, 2018

(54) Cook peel oil distillation system

(71) Applicants: Charles Steven Cook, Frostproof, FL (US); Seth William Turlington, Frostproof, FL (US); Savino Charles Musella, Lake Wales, FL (US)

(72) Inventors: Charles Steven Cook, Frostproof, FL (US); Seth William Turlington, Frostproof, FL (US); Savino Charles Musella, Lake Wales, FL (US)

(21) Appl. No.: 15/731,878

(22) Filed: Aug. 17, 2017

Related U.S. Application Data
(60) Provisional application No. 62/454,702, filed on Feb. 3, 2017.

(51) Int. Cl. C11B 3/14; C11B 1/10; B01D 3/10

(52) U.S. Cl. CPC C11B 3/14; B01D 3/10; C11B 1/108

(57) ABSTRACT

A hollow vessel operated under vacuum receives whole orange peel delivered by a conveyor. The peel is heated indirectly by steam. Oil and water present in the peel evaporates and is drawn off to be condensed, captured and separated. Separation is by decantation. Operation under vacuum lowers the boiling point of the oil. Steam condensate is collected for reuse. The exiting peel discharges from the vessel and is conveyed away for further processing.

Interior Cavity: Orange peel is heated and volatile oils and water are evaporated.

Inner Shell: Bottom portion is circular, top portion is elliptical. Top portion is elongated to provide a space for the vaporized product. A space is provided between the inner and outer shell for heating steam.

Outer Shell: Bottom portion is circular, top portion is elliptical. Top portion is elongated to provide vapor space. A space is provided between the inner and outer shell for heating steam.

Steam Jacketed Double Sided Cones: Two cones are placed together with a ring between them. In the cavity between each cone heating steam is injected. The peel flows over these heated cones and vaporizes the entrained peel liquid. All steam cavities have a boundary that separates the heating regions and peel regions. The cones sit on a center axle. The center axle rotates and is also filled with steam. The axle has holes where the cones contact the axle to allow steam and steam condensate to flow through them.

Cone Rings: Between each jacketed cone is a metal ring for stability. In addition, holes are placed on the outer edge of the ring for the paddle holders (see item [10] for more information) to be connected.

Rotary Joint: The rotary joint allows steam and steam condensate to flow through the rotating cavities. The rotary joint has two connections that are coaxial to each other. The smaller inner connection allows condensed steam to exit the rotating bodies through a siphon tube and back out of the heating regions.

Siphon Tube/Condensate Drain: A siphon tube is used to discharge the condensed heating steam. The tube is placed in line with a thermodynamic disk trap, allowing only condensed steam to exit, minimizing the loss of steam when discharging.

End Holder: Located on the drive end of the axle are two plates that connect to a ring. The ring has connecting plates that grip and attach to the first jacketed cone. The first jacketed cone is located by the shell's drop where the peel first enters the machine.

Steam Rings: Between the inner and outer shell ([2] and [3] respectively) are the steam rings. Along the ring's center circumference are orifice holes. Steam is injected between the two shells and the orifice holes allow steam to flow between the cavities. The peel contacts the surface of this jacketed shell and vaporizes the entrained liquid. These steam rings also provide support for the shells.

Peel Paddles: Each of the cone rings between the jacketed cones are connections to attach paddles. The paddles are tilted at a 45 degree angle in the direction of desired peel flow. These paddles also provide mixing and prevent any orange peel from building up on the shell walls.

Final Jacketed Cone: After the chute or exit location of the peel, is another jacketed cone. This cone is larger than the other preceding jacketed cones. This cone provides a boundary between the front end of the shell.

Cone Keys: Between each jacketed cone are 3 keys. The keys are spaced 120° from each other. They provide support between each cone. The keys also provide interior walls that assist with removing steam condensate.

Cone Rods: Each of the jacketed cones have aligning holes on both sides for a solid round bar to be inserted. The round bars are welded to the jacketed cones.

Peel Scraper System: Along the length of the rotating body there are spaces between the jacketed cones; a peel scraper system has been added between these spaces. The system composes for a holder, a shear pin, and a scraper arm. This system allows the peel to mix.

Axle Flange: The center axle is partitioned into two sections. A smaller section is flanged for removal of the tail shaft. This allows maintenance for the siphon tube.

Drive shaft. The rotating body of the machine is chain-driven by a drive shaft. The drive shaft is attached to a sprocket and chain assembly. The power source to drive the rotation is an AC motor.

Tail Shaft: Located at the end of the center axle. This shaft has a straight bore that allows the flow of steam and steam condensate.

### Peel Feed and Discharge

Double Sliding Gates: On the inlet of the shell where the peel first enters, there are two actuated sliding gates. These gates operate on timers and allow the inner cavity of the shell to maintain pressure. As one gate closes the other is opened and continuously cycles in this manor to feed peel into the system.

Inlet Chute: Where the orange peel enters the inner cavity of the machine.

Outlet Drop: Where the orange peel is discharged from the machine.

### Condenser

Overhead Condenser: Sized for the capacity of vapor mixture that is evaporated from the orange peel. The vapors that are generated within this machine are collected and condensed in the overhead condenser. The condenser is a shell and tube heat exchanger. The shell is where the distillate is condensed. The condenser tubes have a continuous flow of coolant.

Vapor Ducts: The vapor ducts provide a connection between the machine's interior body and the overhead condenser. The ducts are placed at different stages of the vaporization/distillation process. In addition the ducts are double-elbowed to prevent condensed liquid from dripping back into the machine's interior.

Coolant Connections: A coolant is fed in the tubes of the overhead condenser to provide cooling to condense the vapors generated from the orange peel.

Product Drain Lines: The vapor generated by the heated orange peel is condensed then drained out of the condenser. Multiple drain ports are present to quickly drain the liquid oil and water product mixture to minimize re-vaporization of product.

### Decant Tank

Decant Tank: The drain lines connect to a decant tank which separates the oil and water products.

Water Drain: The water is collected from the overhead condenser and is recycled.

Oil Drain. The oil from the overhead condenser is collect and stored. About 95 percent of the oil phase is D-limonene, the rest consists of terpenes and other oil soluble compounds used in the flavor and aroma industries.

### Vacuum System or Suction Fan

To assist with withdrawing the generated vapors from the inner cavity to the condenser and to lower the system pressure, a vacuum pump or suction fan may be used. Based upon the throughput or model type either one may be used to achieve the same physical state of the system.

### Vacuum System

Vacuum Line: The non-condensable gases from inside the interior of the machine are evacuated through the overhead condenser. Placing the vacuum line on the end of the condenser creates a pressure gradient that draws the vapors to the condenser.

Liquid Ring Vacuum Pump: The vacuum pump evacuates non-condensable gases from the interior of the system, creating a partial vacuum and lowering the liquid's boiling point.

Vacuum Pump Discharge Line: The non-condensable gases are then discharged to the atmosphere.

### Suction Fan

Suction Fan Connection: The inlet of the suction fan is attached to the shell of the condenser where the product is condensed.

Liquid-Vapor Separator: In the even that some of the condensed product in the condenser is drawn up to the fan connection, a separator is placed in line with the fan.

Liquid Drain Line: The liquid from the fan's liquid-vapor separator flows back into the condenser via this piping.

Fan Rotor: The rotating body that allows the draw of gases for the shell interior to the condenser.

Fan Housing: This steel housing encloses the fan rotor.

Non-Condensable Discharge: The non-condensable gases are removed from the system via this outlet.

Fan Motor: The fan is driven by an AC motor that is mounted on top of the fan housing.

1. The process of volatizing citrus peel oil under vacuum using the device and process as presented has not been previously done and therefore constitutes a unique piece of equipment (the cooking vessel) and a unique process.

2. The oval shape and the two-shell arrangement is unique to the design of the cooking vessel.

3. The design and use of the axial cones is unique to the cooking vessel.
